(19) United States
(12) Patent Application Publication
(10) Pub. No.: US 2017/0189726 A1
(43) Pub. Date: Jul. 6, 2017

(54) Wearable Casualty Sled

(71) Applicant: Carlton Parrish, Walters, OK (US)

(72) Inventor: Carlton Parrish, Walters, OK (US)

(21) Appl. No.: 14/986,664

(22) Filed: Jan. 2, 2016

(51) Int. Cl. A62B 5/00; A61G 1/06; A61G 1/013

(52) U.S. Cl. CPC A62B 5/00; A61G 1/013; A61G 1/06; A61G 2200/34

(57) ABSTRACT

A wearable rescue sled constructed of a durable sheet material having a smooth, low-friction surface, an upper edge, a lower edge, and two side edges, with attachments along the upper edge for attaching the sled to a rear panel of a vest such as a military or law enforcement protective plate carrier vest. A releasable stowing retainer holds the sled in a stowed position with the approximately conformant to the rear panel of the vest. To effect a rescue of the sled's wearer, a rescuer releases the stowing retainer such that the sled hingably swings or slides down to depend from the attachments, forming a flexible low-friction seat for dragging a wearer of the vest. The rescuer may now drag the wearer in a semi-inclined seated position wherein the sled rides between the hips of the wearer and the ground surface to reduce friction and snag dangers.

### FIELD OF THE INVENTION

The invention generally relates to sleds and litters for transporting injured or incapacitated persons from fires, battlefields, and other dangerous environments.

### BACKGROUND OF INVENTION

Many teams who work in dangerous environments are finding themselves working in smaller numbers. Generally speaking, increased technology has made team members more effective, which reduces the need for additional team members with specific skills. And, budgetary constraints also factor into team size reductions.

For example, special operator teams of 5-10 members are not heavily relied upon by militaries around the world. Each member is capable of doing many of the tasks of several members from just a decade ago due to increased skill cross-training, improved technologies, and reduction of weight of certain gear.

Similarly, fire fighters often work in smaller teams for similar reasons—each firefighter is more capable of a greater number of specialized tasks, and improved technologies allow the same jobs to be done by fewer men and women.

A consequence of these smaller-sized teams is that when one member becomes injured or incapacitated, there are fewer able-bodied team members available to help evacuate the wounded member. And, members who are engaged in the evacuation often must simultaneously stay engaged in the work of the mission, whether that be returning gunfire to enemy soldiers or fighting a forest fire.

### SUMMARY OF EXEMPLARY EMBODIMENTS OF THE INVENTION

A wearable rescue sled is disclosed which is constructed of a durable sheet material having a smooth, low-friction surface, an upper edge, a lower edge, and two side edges, with attachments along the upper edge for attaching the sled to a rear panel of a vest such as a military or law enforcement protective plate carrier vest. A releasable stowing retainer holds the sled in an stowed position approximately conformant to the rear panel of the vest. To effect a rescue of the sled's wearer, a rescuer releases the stowing retainer such that the sled hingably swings or slides down to depend from the attachments, forming a flexible low-friction seat for dragging a wearer of the vest. The rescuer may now drag the wearer in a semi-inclined seated position wherein the sled rides between the hips of the wearer and the ground surface to reduce friction and snag dangers.

### BRIEF DESCRIPTION OF THE DRAWINGS

The description set forth herein is illustrated by the several drawings.

FIG. 1 illustrates a rescue sled in its flattened state.

FIG. 2. shows a perspective view of a exemplary protective plate carrier vest suitable for using the rescue sled.

FIG. 3 illustrates a back view of the exemplary protective plate carrier vest of FIG. 2.

FIG. 4 shows a left side view of the exemplary protective plate carrier vest of FIG. 2.

FIG. 5 sets forth one embodiment of the present invention in which the sled is deployed below the bottom rear panel of the exemplary protective plate carrier vest.

FIG. 6 provides top, lower edge and left edge views of a particular embodiment including ridges to promote easy of sliding.

FIG. 7 shows a left-side view of the rescue sled in a dragging configuration.

FIG. 8 depicts a perspective view of the rescue sled in a dragging configuration.

FIG. 9 provides a view of the rescue sled in a stowed position.

FIG. 10 illustrates an optional embodiment feature of a pack, pouch or roll with additional accessories such as a drag tether and/or a full-length cloth litter.

FIG. 11 provides a left-side view of the embodiment introduced in FIG. 10.

FIG. 12 illustrates another embodiment in which the sled portion stows into a pack by sliding up into the pack rather than hinging.

### DETAILED DESCRIPTION OF EXEMPLARY EMBODIMENT(S) OF THE INVENTION

The present inventor has realized that the existing tools for evacuating wounded team members from a dangerous environment to a safe location where they may receive medical treatment are not suitable for the small-footprint teams of today. Thus, it has been realized by the inventor that would be highly advantageous for any new litter type of device to be single-man portable, lightweight, and very quick to deploy.

Having reviewed a variety of existing lightweight compact litter products, the present inventor found shortcomings in all of them relative to today's small-footprint mission profile. For example, many firefighter drag harnesses presume that the team member is wearing a very heavy duty, long-length (below the waist) “turnout coat”, which becomes somewhat of a drag sled when another firefighter pulls on the collar. These long length coats are not suitable for use in combat or police tactical missions, however.

Another common litter is a body-length sheet of plastic which is normally kept rolled up until needed. When needed, it is unrolled, the wounded team member is slid or lifted onto the litter, and then the longitudinal edges are pulled together by straps over the top of the member's body, i.e. across the chest, hips and legs, to form a curl down the length of the litter and stiffen it. Then, it can be lifted and carried by handles, or dragged behind one or two members of the team. However, even the fastest of experienced users take a minimum of 60 seconds to un-roll, position, move the wounded, fasten the straps, and prepare to move. While this seems quick in theory, if the rescuing member is under gun fire or threat of approaching building flames, 60 seconds can be an eternity and quite dangerous.

Host Vest.

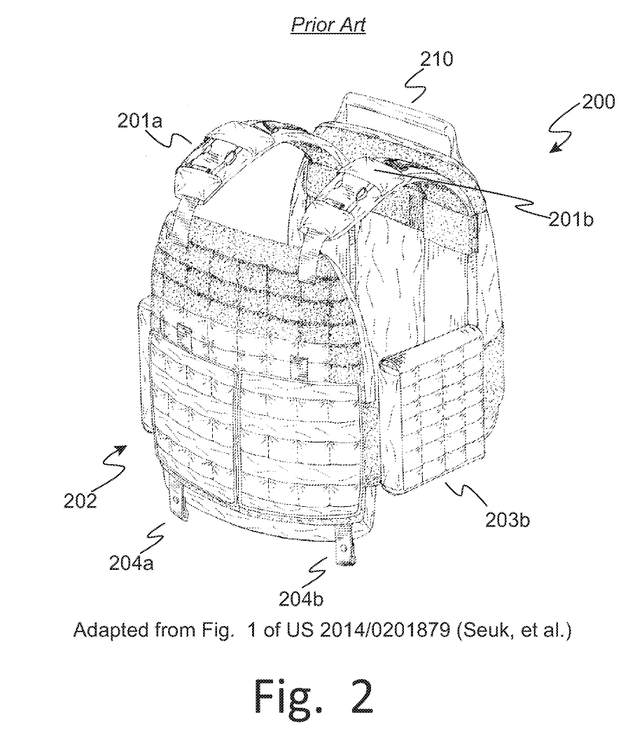

Embodiments of the present invention are especially useful when used in conjunction with a vest, such as a climbing vest, an integral drag vest in a fireman's coat, or a military or law enforcement protective plate carrier vest (200) such as that shown in FIG. 2. This vest, and the sketches thereof, are fully described in unrelated U.S. Patent Application Publication 2014/0201879 to Seuk, et al. It is use only as an exemplary host vest, and those skilled in the art will recognize that the present invention may be realized in a variety of embodiments suitable for attachment to other makes, models, and types of safety vests and harnesses.

To provide context for the disclosure of the exemplary embodiments, we shall refer to a vest front panel (202) which generally is positioned on the chest and/or belly of a wearer, a vest rear panel (not visible in this view), one or more shoulder straps (201a, 201b), front accessory attachment straps (204a, 204b), and a drag or lift handle (201) position near a top of the vest rear panel.

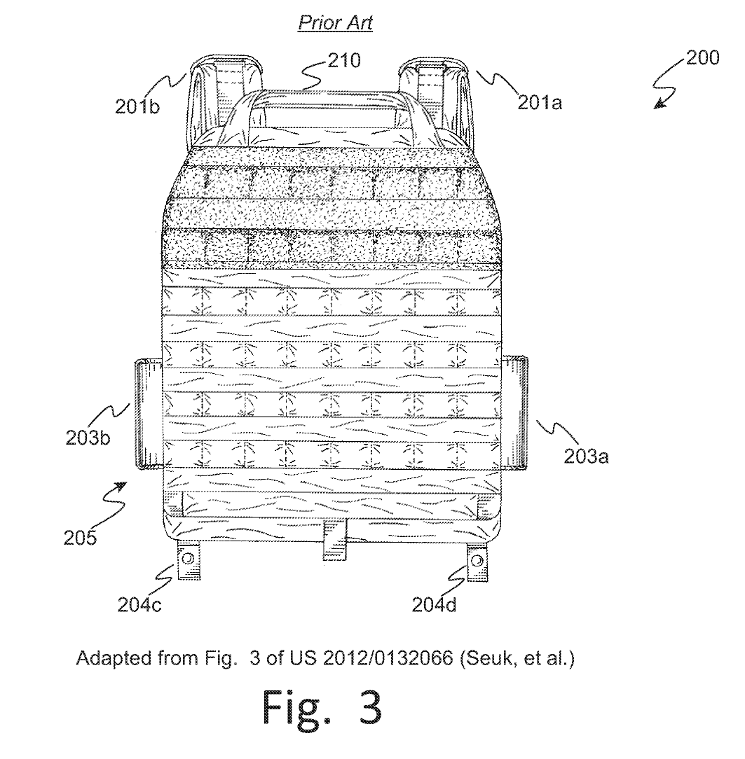

Referring now to FIG. 3, a rear-view of the exemplary Seuk plate carrier vest is shown, in which two side panels (203a, 203b) can be seen, and one or more rear accessory attachment straps (204c, 204d). Also, from this view and that of FIG. 2, one can see a series attachment loops which are constructed from a set of horizontal strips of material, stitched periodically to the vest, with the unstitched segments forming the attachment loops, such as the Modular Lightweight Load-carrying Equipment (MOLLE) and Pouch Attachment Ladder System (PALS) attachment systems used by the U.S. military and allied forces.

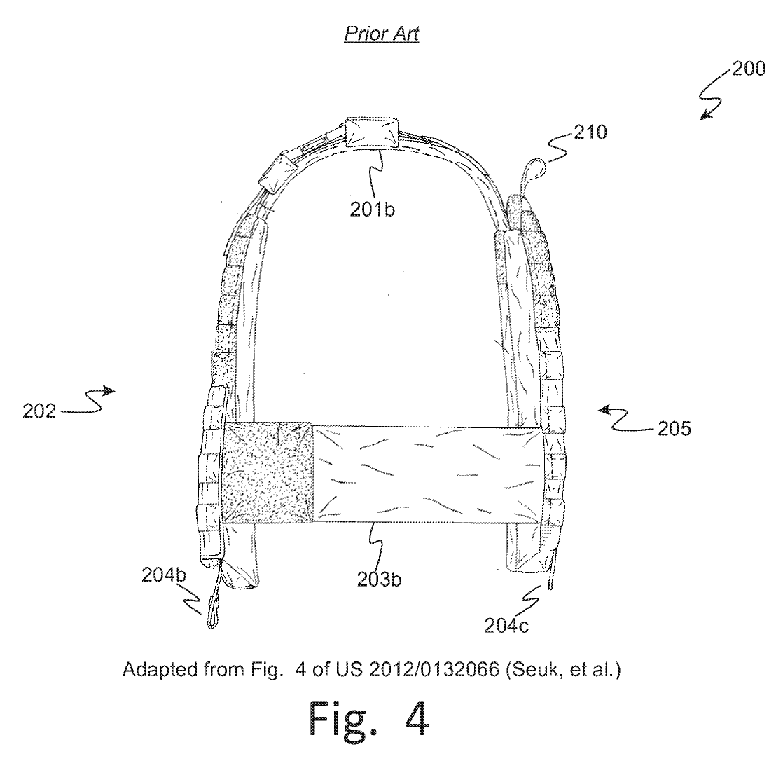

And, FIG. 4 provides a left-side view of the exemplary plate carrier vest (200) as taught by Seuk, in which the left side (203b) connection is shown, left edges of the vest front panel (202) and vest rear panel (205) can be seen connected across the top by a shoulder strap (201b), with the drag handle (210).

This host vest will be used only for illustrative purposes of the structure and manner of use of the embodiments of the present invention, and does not form a part of the invention nor does it limit the embodiments of the invention to use only with this particular host vest.

The Wearable Rescue Sled.

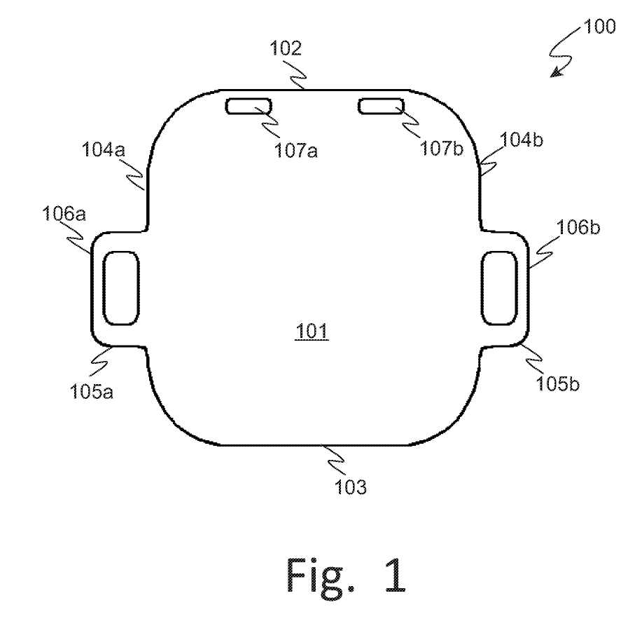

Turning to FIG. 1, a flattened front view of a rescue sled (100) is shown, in which a main sheet of strong and flexible material has a seat area (101) bounded by a left edge (104b) (referenced to the wearer's left), a right edge (104a), a top edge (102) and a bottom edge (103). One or more attachment orifices, tabs, or holes (107a, 107b) are formed near the top edge (102). Optionally, the sled (100) may have one or more side grab handles (105a, 105b) formed therein or attached thereto. The strong, flexible material can be any suitable sheet material which can withstand the rigors of being slid or dragged over a variety of terrain, including but not limited to dirt, gravel, concrete, bricks, mud, sand, tile, carpet, and wood while being loaded with an typical human with necessary gear (firefighting gear, military gear, law enforcement gear, etc.), and be strong enough to be pulled by an edge and not tear or rip, while also being light weight and reducing friction between the seat of pants of the wearer and the ground. A variety of plastics, such as polymers and polystyrene, are suitable, as well as various fabrics such as rip-stop nylon and ballistic nylon. One such plastic material can readily be found in a retail product used to line a trash bag while filling it with leaves, sticks, or construction debris manufactured by Lawson Products Inc. and sold as Easy Bagger™ 40500. Another such plastic material is commonly used to fabricate deer and game sleds.

Achieving the basic shape and feature of the exemplary embodiment (200) and other embodiments may be accomplished by cutting (blade, laser, water jet, etc.) or stamping (e.g., die cutting) a bulk sheet material, molding (e.g., injection, blow, etc.), or stitching. In practice, the sled may be a single or unitary device, or it may be comprised of two or more components, panels, and/or layers.

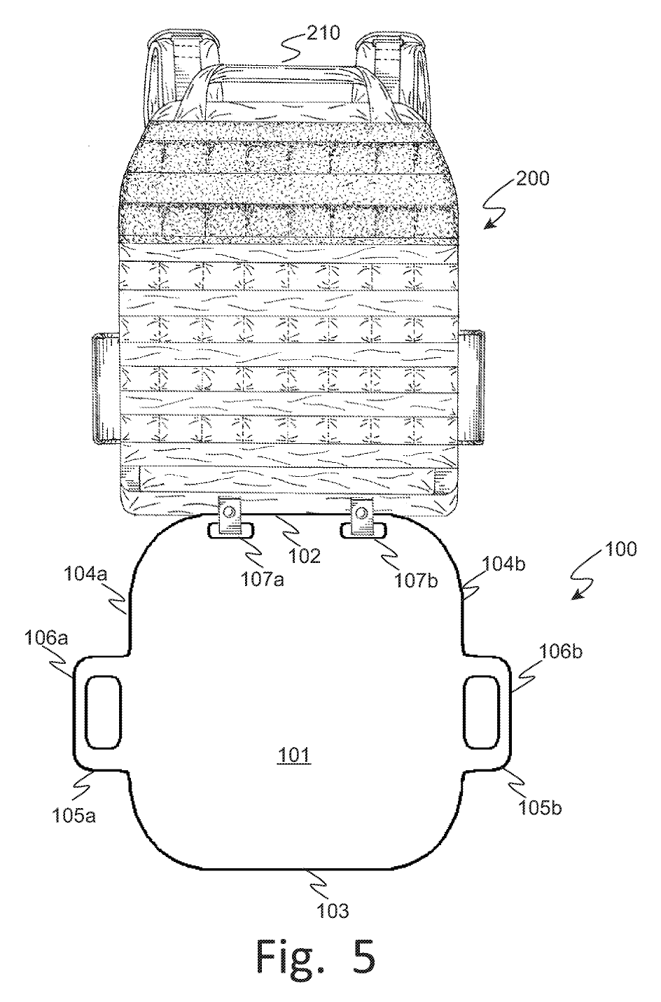

Referring now to FIG. 5, the rescue sled (100) is shown attached to the vest (200) towards a lower extremity of the vest rear panel, but not necessarily at the exact bottom edge of the vest rear panel. Attachment is via a hinge or pivotal means, such as the accessor straps (204c, 204d), the MOLLE webbing, or via other suitable scheme (tying, stitching, hook-and-loop fasteners, etc.). In the configuration shown in FIG. 5, the sled (100) is hanging downward in the same manner that it used to drag the wearer using the vest's drag handle (201) or via an optional tether.

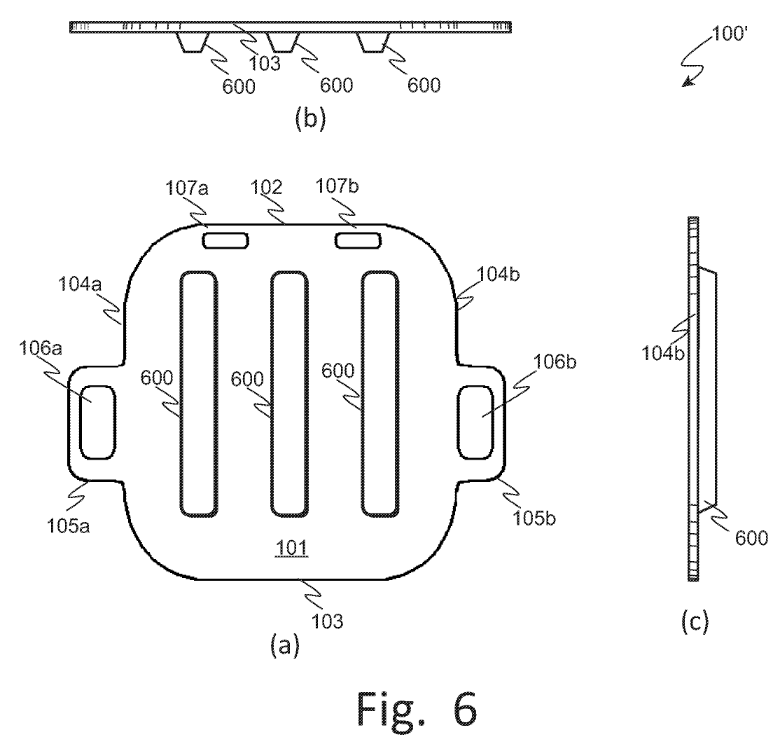

FIG. 6 shows a flat view (a) of a variation embodiment which includes one or more ridges (600) which promote sliding, such as debossed ridges. A bottom-edge view (b) and left-edge view (c) illustrate the depth or height of the ridges.

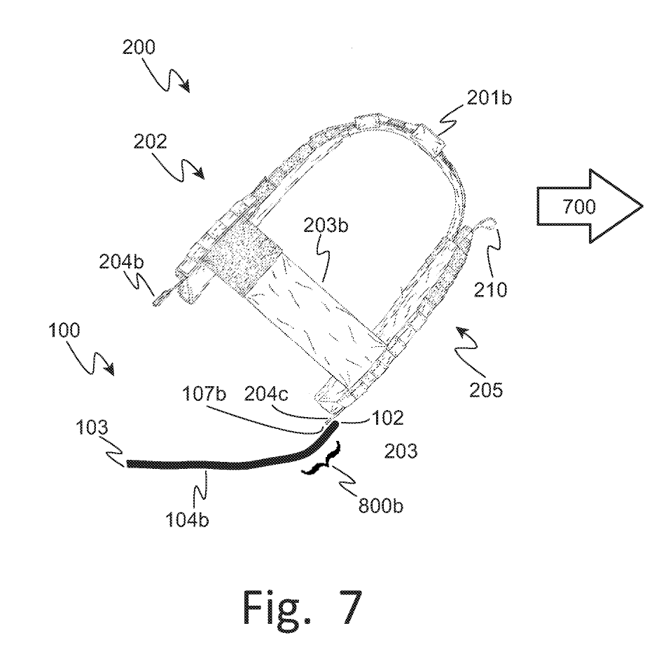

A left-side view of this configuration is shown in FIG. 7, in which the left-edge (104b) of the sled is presented, and the sled's bottom edge (103) becomes a trailing edge while being dragged by applying a force (700) to the vest's drag handle (210) or via an optional tether. In this configuration, the flexible sheet material of the sled (100) forms a bending angle (800b) between the upper edge (102) and the lower edge (103), thereby providing a seat for the wearer (not shown). When the wearer's shoulders are elevated such that his or her torso is at an angle, such as that shown by the position of the vest (200) in this figure, the majority of the wearer's body weight is placed on the seat formed by the bent sled (100). Without the sled, the vest wearer's body weight would be impinging on the ground through the wearer's pants, which may be of a relatively high friction coefficient with the ground, and the features of which (e.g., pockets, holster rigs, utility loops, etc.) may form a snag hazard when being dragged. However, with the sled positioned in a manner such as this, the dragging effort (700) is significantly lessened due to the improved friction coefficient, and the snag hazard is minimized by covering the pants feature and by forming a toboggan-like leading edge (800b). This leading edge, being rounded and slick, allows the rescuer to easily lift or drag the wearer over bumps, rises and even stairs.

The attachment points (107a, 107b, 204c, 204d) of the top edge (102) of the sled to the vest maintain the sled in position underneath the wearer's hips, and prevents the sled from being left behind as the wearer is advanced in the direction of the dragging force (700).

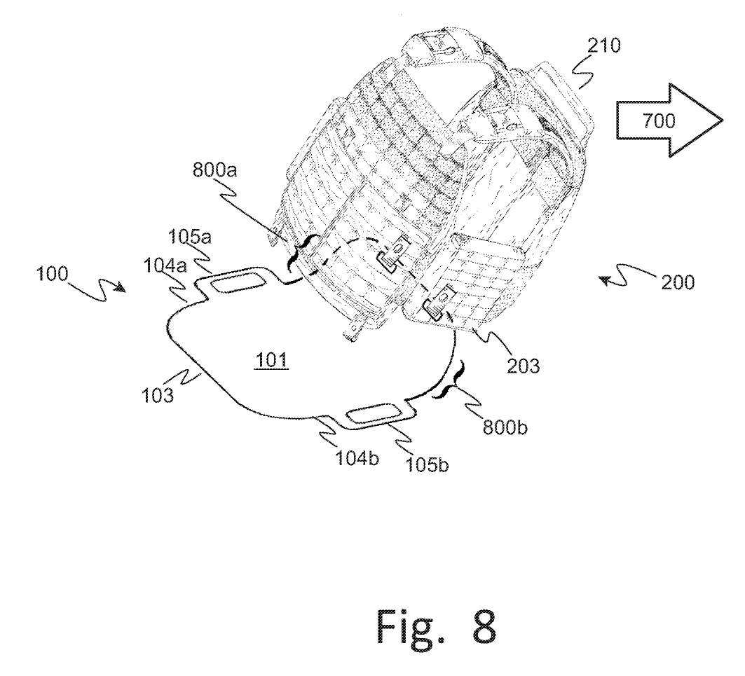

FIG. 8 provides a perspective view of the sled-configuration shown in FIG. 7, in which the sled is bent to form a semi-elevated seat in which the wearer rides while being dragged (700). In this particular view, one can see the usefulness of the optional side handled (105a, 105b), which can be held by the wearer while dragging to stabilize themselves, or used by rescue personnel to help lift the wearer over obstacles, into vehicles, etc.

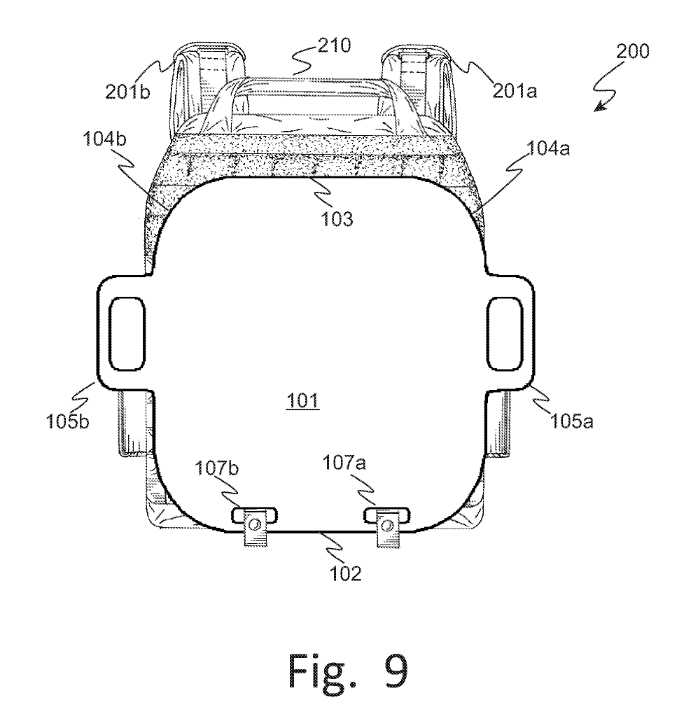

Now referring to FIG. 9, the stowed position of the sled (200) is shown in which the lower edge (103) is raised above the upper edge (102), hinging it on the attachment points (107a, 107b, 204c, 204d) such that the sled is positioned essentially flat and parallel to the vest rear panel of the vest (200). To retain the sled in this position, a number of retention means may be employed, such as a straps, snaps, hook-and-loop fasteners, magnets, non-permanent glue, ties and buckles.

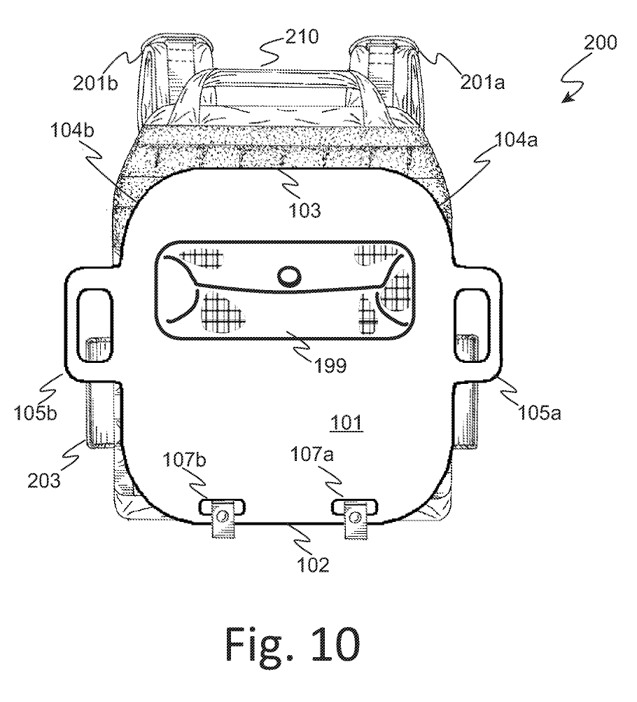

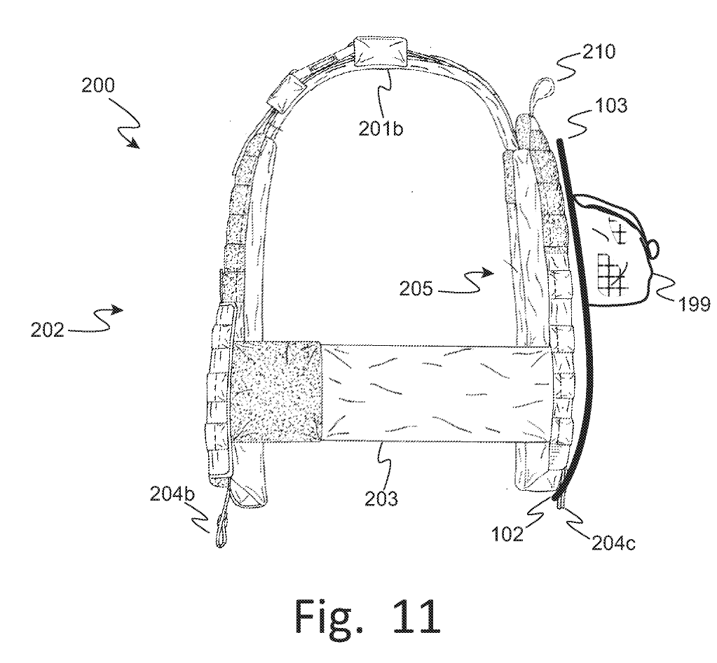

FIG. 10 illustrates an optional embodiment feature of a pack or pouch (199) disposed or attached to the sled (100) to hold a variety of optional features, such as a tow tether, an folded or rolled full-length cloth litter, or other supplies such as first aid supplies. FIG. 11 provides a left-side view of the optional embodiment of FIG. 10.

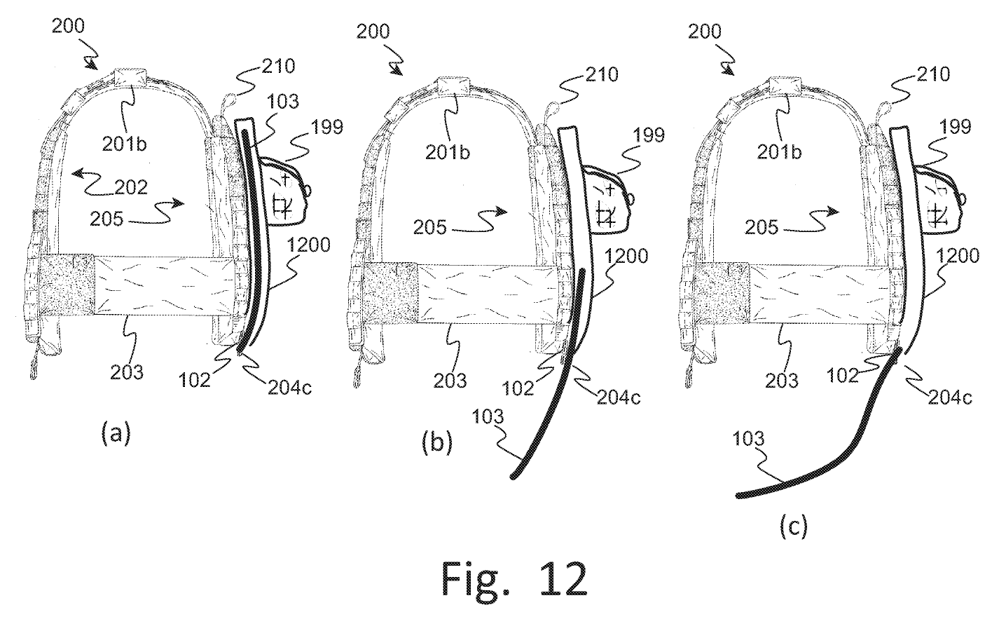

FIG. 12 illustrates another embodiment according to the invention in which the sled portion (103) stows (a) into a pack (1200) by sliding up into the pack rather than hinging, thereby allowing the presentation of webbing on the pack for the addition of accessories and other gear. This variation in embodiment deploys the sled (103) by releasing a retention means (e.g., snap, strap, hook-and-loop fastener, etc.), and sliding (b) the sled (103) downwards until it reaches and lowered extreme position (c) in which the upper edge it retained to the bottom of the pack (1200) or vest (200), or both.

### SUMMARY

The foregoing exemplary embodiments are intended to teach how to make and use the invention, but not to express the limits of the spirit and scope of the invention. In some embodiments, a disclosed singular element may be replaced by a plurality of elements, and vice versa, without departing from the spirit and scope of the invention. Alternative materials from those disclosed in the exemplary embodiments may be employed, so long as the function and intended performance is maintained or improved.

1. A wearable rescue sled for evacuating a casualty:
a sled comprising a durable sheet material having a smooth surface, and bounded by an upper edge, a lower edge, and two side edges;
one or more attachments disposed proximate to the upper edge and configured to attach to a lower edge of a rear panel of a vest;
a releasable stowing retainer which holds the sled in an stowed position approximately aligned with and conformant to the rear panel of the vest, and which, when released, allows the sled to be moved into a deployed position depending downwards from the attachments, presenting the smooth surface away from contact with the wearer, thereby forming a flexible low-friction seat for dragging a wearer of the vest.

2. The wearable rescue sled as set forth in claim 1 wherein the movement into the deployed position comprises sliding.

3. The wearable rescue sled as set forth in claim 1 wherein the movement into the deployed position comprises pivoting and the one or more attachments comprise hinging attachments.

4. The wearable rescue sled as set forth in claim 1 wherein the smooth surface comprises one or more ridges.

5. The wearable rescue sled as set forth in claim 1 wherein the durable sheet material comprises a sheet of flexible plastic.

6. The wearable rescue sled as set forth in claim 1 wherein the durable sheet material comprises a fabric.

7. The wearable rescue sled as set forth in claim 1 wherein the hinging attachment comprises one or more attachments selected from the group consisting of a strap, a buckle, a snap, a hook-and-loop fastener, a MOLLE web, a PALS web, stitching, and a zipper.

8. The wearable rescue sled as set forth in claim 1 further comprising one or more side handles disposed along one or more of the two side edges.

9. The wearable rescue sled as set forth in claim 1 further comprising a tether stowed on the sled.

10. The wearable rescue sled as set forth in claim 1 further comprising a folded or rolled fabric litter stowed on the sled.

11. A wearable rescue litter (as opposed to sled in claim 1) for evacuating a casualty:
a pouch having an interior, a closure means, and an attachment means suitable for attachment to an host item selected from the group consisting of a strap, a buckle, a snap, a hook-and-loop fastener, a MOLLE web, a PALS web, stitching, and a zipper; and
a stowable litter disposed in the interior of the pouch such that, upon releasing of the closure means, the fabric litter may be unpacked to carry a wearer.

12. The wearable rescue litter as set forth in claim 11 wherein the stowable litter is stowable by one or more packing actions selected from the group consisting of folding, rolling, and crushing.

13. The wearable rescue litter as set forth in claim 11 wherein the stowable litter comprises a full-length litter upon unpacking.

14. The wearable rescue litter as set forth in claim 11 further comprising:
a sled comprising a durable sheet material having a smooth surface, and bounded by an upper edge, a lower edge, and two side edges;
one or more attachments disposed proximate to the upper edge and configured to attach to a lower edge of a rear panel of a vest;
a releasable sled stowing retainer which holds the sled in an stowed position approximately aligned with and conformant to the rear panel of the vest, and which, when released, allows the sled to be moved into a deployed position depending downwards from the attachments, presenting the smooth surface away from contact with the wearer, thereby forming a flexible low-friction seat for dragging a wearer of the vest.

15. The wearable rescue litter as set forth in claim 14 wherein the movement into the deployed position comprises sliding.

16. The wearable rescue litter as set forth in claim 14 wherein the movement into the deployed position comprises pivoting and the one or more attachments comprise hinging attachments.

17. The wearable rescue litter as set forth in claim 14 wherein the smooth surface comprises one or more ridges.

18. The wearable rescue litter as set forth in claim 14 wherein the durable sheet material comprises one or more materials selected from the group consisting of a sheet of flexible plastic, and fabric.

19. The wearable rescue litter as set forth in claim 14 further comprising one or more side handles disposed along one or more of the two side edges.

20. The wearable rescue litter as set forth in claim 1 further comprising a tether stowed in the pouch.
